(19) United States
(12) Patent Application Publication
(10) Pub. No.: US 2004/0096726 A1
(43) Pub. Date: May 20, 2004

(54) Fuel cell and related method

(76) Inventor: Naoki Takahashi, Yokohama-shi (JP)

Correspondence Address: FOLEY AND LARDNER, SUITE 500, 3000 K STREET NW, WASHINGTON, DC, 20007, US

(21) Appl. No.: 10/469,546

(22) PCT Filed: Dec. 25, 2002
(86) PCT No.: PCT/JP02/13512

(30) Foreign Application Priority Data
Jan. 10, 2002 (JP) 2002-003559

(51) Int. Cl. H01M 8/02

(52) U.S. Cl. 429/38; 429/39; 429/13

(57) ABSTRACT

A fuel cell is provided with an electrolyte layer (13, 46), a first electrode layer (14, 43) adjacent to one surface of the electrolyte layer, a first separator (1, 21, 31) adjacent to the first electrode at one surface thereof remote from the electrolyte layer and formed with a flow passage (5, 4, 23, 22, 24, 31, 32, 33, 34, 35, 39, 80, 91), a second electrode layer (15) adjacent to the other surface of the electrolyte layer and a second separator (2, 45) adjacent to one surface of the second electrode layer remotest from the electrolyte layer and formed with a flow passage (7, 8, 9, 4a, 10, 26, 27, 28, 29, 39, 60, 70, 71, 72, 73b, 80, 101). The flow passage formed on at least one of the first separator and the second separator includes at least a part of fuel gas flow passage and at least a part of oxidizing gas flow passage.

### TECHNICAL FIELD

The present invention relates to a fuel cell and a related method and, more particularly, to a solid polymer type fuel cell using a solid polymer as electrolyte material and its related method of flowing gases.

### BACKGROUND ART

A cell structure of a solid polymer type fuel cell is arranged in such a manner that catalytic layers are located on both sides of an electrolyte layer composed of a polymer layer with a proton conductivity whereupon dispersion electrode layers, composed of respective films attached with gas dispersion electrodes, are disposed on respective catalytic layers and the respective dispersion electrodes are provided with separators, i.e., more specifically, a separator formed with flow passages to flow hydrogen containing gas serving as fuel gas at an anode side and a separator formed with flow passages to flow oxygen containing gas serving as oxidizing gas at a cathode side, with these components being held in a sandwiched configuration to form the cell structure.

Japanese Patent Application Laid-Open Publication No. H11-67258 discloses gas flow passage configurations for a fuel cell specified for the purpose of controlling temperatures. More particularly, a stack with a plurality of cells sandwiched with pairs of separators is disclosed wherein, with a view to controlling the temperatures, adjacent one cell is configured to have a fuel gas flow passage and an oxidizing gas flow passage arranged to cause relevant gases to flow in directions opposite to one another and another cell is configured to have the fuel gas flow passage and the oxidizing gas flow passage arranged to cause relevant gases to flow in directions parallel to one another.

Japanese Patent Application Laid-Open Publication No.2001-126746 discloses a gas flow passage configuration for a fuel cell specified for the purpose of controlling moisture. More particularly, the fuel cell is disclosed as having a plurality of gas flow passages formed between a gas supply manifold and an exhaust gas manifold formed in a separator to deliver oxidizing gas to the gas exhaust manifold while forming a plurality of turns to cause a stream of oxidizing gas to be opposite to those of gases flowing through the respective gas flow passages for thereby enabling moisture to be controlled.

### DISCLOSURE OF INVENTION

According to considerable studying works undertaken by the present inventor, there is a need for the reaction gas flow passages, formed on the separator of the cell of the solid polymer type fuel cell or the like, to meet various conditions as described below.

For example, in order for hydrogen and oxygen to react with one another to efficiently achieve electric power generation, while the fuel cell is required to transfer so-called reaction gas to the surfaces of the electrode in a wide range, since reaction gas in the fuel cell is consumed on the surfaces of the electrode, the greater the distance in the downstream of the flow passage where gas flows, the lower will be the flow rate of gas. Consequently, in order for reaction gas to be transferred onto the surface of the electrode in a desired distribution pattern, the flow passage of reaction gas must be suitably designed.

Further, even though the fuel cell generates heat accompanied by electric power generating reaction, the temperature must be controlled in an appropriate range in order for the fuel cell to be maintained in a suitable operating condition. When employing reaction gas as one of heat medium for such a temperature control, there is a need for the reaction gas flow passage to be properly designed to control heat transfer due to reaction gas.

Further, since the electrolyte layer of the solid polymer type fuel cell is hard to transfer proton under a condition with no moisture. For this reason, in general, reaction gas is supplied to the fuel cell after being applied with moisture with a moistening device. On the other hand, since water is created in the cathode due to electric power generating reaction, there is a tendency in that the greater the distance in the downstream of reaction gas, the more excessive will be the moisture content in gas. Since such moisture is dispersed onto the anode due to moisture concentration gradient appearing in the electrolyte layer. Accordingly, in order for such moisture to be appropriately controlled, it is required to take a structure in that an upstream area and a downstream area for reaction gas are disposed adjacent to one another to permit moisture to be dispersed from the downstream area to the upstream area of reaction gas via a gas dispersion electrode layer.

However, supposing that the reaction gas flow passage in the solid polymer fuel cell is formed in a recessed configuration dug in one surface of the flat shape separator so as to oppose to the electrolyte layer, an inlet and an outlet for reaction gas must be present on the same plane, and it becomes hard to provide a flow passage intersecting area to permit streams of reaction gas to intersect one another without being mixed. Consequently, when using the flat shape separator, the flow passage configuration encounters certain restrictive conditions. In an event that the reaction gas flow passage is configured to include a plurality of parallel flow passage components so as to cause these flow passage components to intersect one another, the plurality of these flow passage components are required to be formed in a shape configured in a single stroke of the brush with no mutual intersections.

Because of reaction gas streams to be prevented from being mixed with one another at the anode area and the cathode area, it is required to have a structure so as to prevent the flow passages for anode gas and cathode gas from being simultaneously formed on the same plane of the separator at a side on which the electrolyte layer is held in contact except for an area in which a manifold is formed as a bore extending through the separator.

The restrictive conditions set forth above form restricting conditions derived from restrictions per se in design of the flow passages, resulting in one of causes for narrowing the freedom in design of the flow passages.

It is therefore an object of the present invention to provide a fuel cell and a method of flowing gases which are able to form an anode gas (fuel gas) flow passage and a cathode gas (oxidizing gas) flow passage on the same plane of a separator at a side on which an electrolyte layer is held in contact for thereby increasing the freedom in design of flow passages.

According to a first aspect of the present invention, a fuel cell comprises: an electrolyte layer; a first electrode layer adjacent to one surface of the electrolyte layer; a first separator adjacent to the first electrode at one surface thereof remote from the electrolyte layer and formed with a flow passage; a second electrode layer adjacent to the other surface of the electrolyte layer; and a second separator adjacent to one surface of the second electrode layer remote from the electrolyte layer and formed with a flow passage, the flow passage formed on at least one of the first separator and the second separator including at least a part of fuel gas flow passage and at least a part of oxidizing gas flow passage.

Stated in another way, a fuel cell of the present invention comprises: an electrolyte layer; a first electrode layer adjacent to one surface of the electrolyte layer; a first separator adjacent to the first electrode at one surface thereof remote from the electrolyte layer; a second electrode layer adjacent to the other surface of the electrolyte layer; a second separator adjacent to one surface of the second electrode layer remote from the electrolyte layer; first communicating means for communicating fuel gas; and second communicating means for communicating oxidizing gas, at least one of the first separator and the second separator being formed with at least a part of the first communicating means and at least a part of the second communicating means.

On the other hand, the present invention provides a method of flowing gases in a fuel cell, which is provided with an electrolyte layer, a first electrode layer adjacent to one surface of the electrolyte layer, a first separator adjacent to the first electrode at one surface thereof remote from the electrolyte layer and formed with a flow passage, a second electrode layer adjacent to the other surface of the electrolyte layer and a second separator adjacent to one surface of the second electrode layer remote from the electrolyte layer and formed with a flow passage. The method of flowing the gases in the fuel cell comprises: flowing one of the fuel gas and the oxidizing gas to the flow passage of the first separator; introducing the one of the fuel gas and the oxidizing gas, which flows through the flow passage of the first separator, to the second separator; flowing the one of the fuel gas and the oxidizing gas to one part of the flow passage of the second separator; and flowing the other one of the fuel gas and the oxidizing gas to the other part of the flow passage of the second separator.

Other and further features, advantages, and benefits of the present invention will become more apparent from the following description taken in conjunction with the following drawings.

### BRIEF DESCRIPTION OF DRAWINGS

FIG. 1 is an exploded plan view illustrating a cathode side separator and an anode side separator to form a fuel cell of a first embodiment according to the present invention;

FIG. 2 is a cross sectional view of the fuel cell of the first embodiment;

FIG. 3 is a plan view principally illustrating a modified form of a gas dispersion electrode of the fuel cell of the first embodiment;

FIG. 4 is a plan view principally illustrating a cathode side separator of a fuel cell of a second embodiment according to the present invention;

FIG. 5 is a plan view principally illustrating a cathode side separator of a fuel cell of a third embodiment according to the present invention;

FIG. 6 is a cross sectional view of the fuel cell of the third embodiment;

FIG. 7 is an exploded perspective view of the fuel cell of the third embodiment;

FIG. 8 is a plan view principally illustrating a cathode side separator of a fuel cell of a fourth embodiment according to the present invention; and

FIG. 9 is a cross sectional view of the fuel cell of the fourth embodiment.

### BEST MODE FOR CARRYING OUT THE INVENTION

A fuel cell and its related method of flowing gases in each embodiment according to the present invention are described in detail hereinafter with suitable reference to the accompanying drawings.

(First Embodiment)

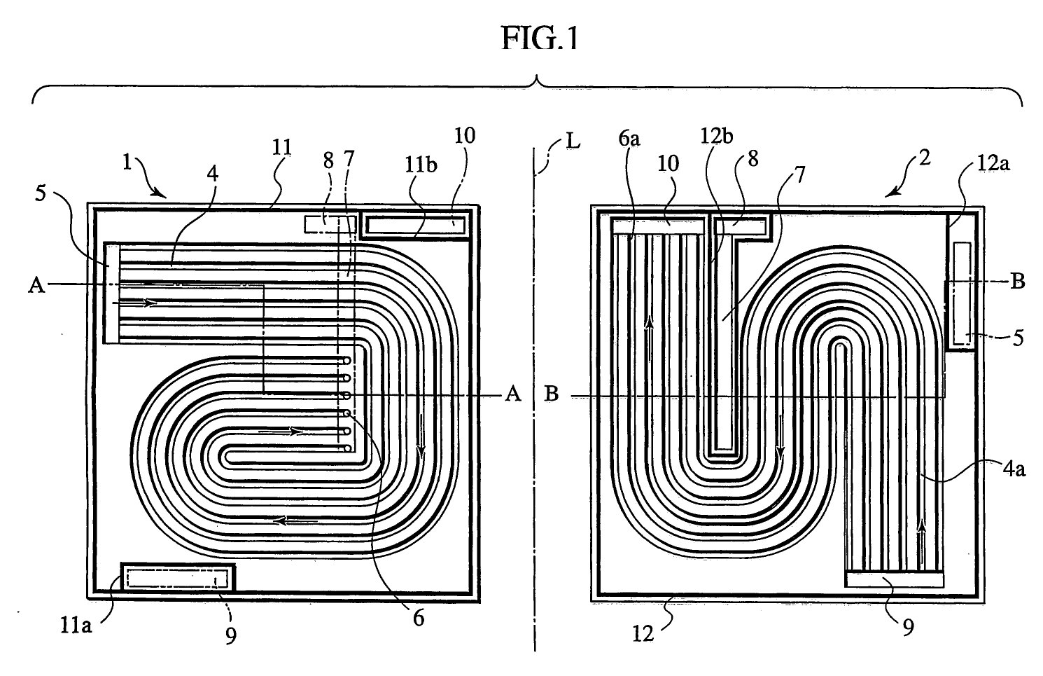

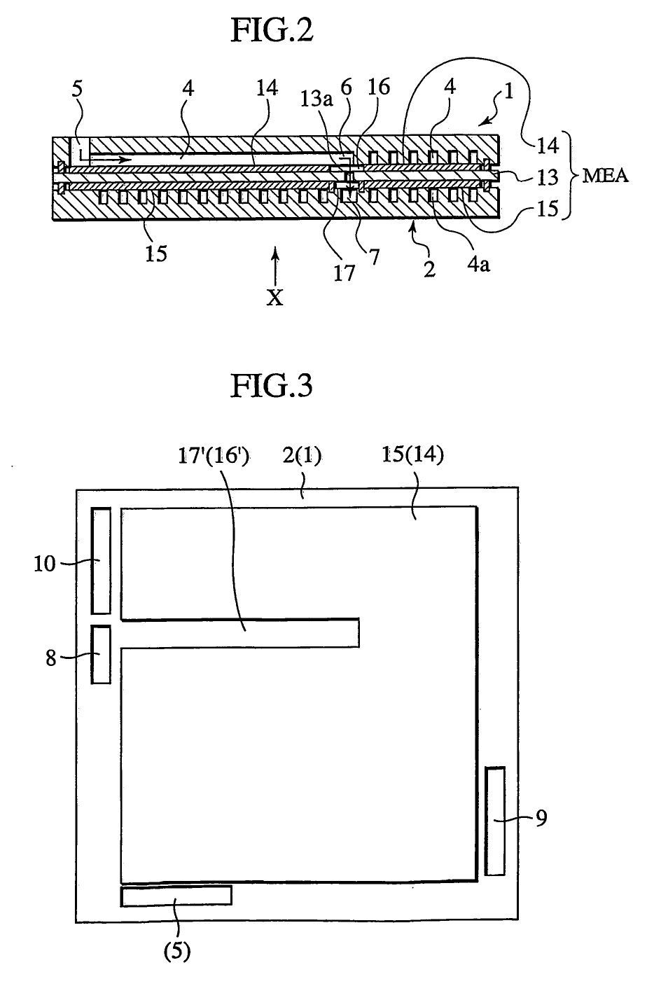

First, a fuel cell and its related method of flowing gases in a first embodiment according to the present invention are described below more in detail with principal reference to FIGS. 1 and 2. Also, the presently filed embodiment is described below in conjunction with a single unit cell extracted from a solid polymer type fuel cell stack.

FIG. 1 is a plan view of main flow passages of a cathode side separator and main flow passages of an anode side separator, as viewed from an electrolyte layer, to allow the main flow passages of the cathode side separator and the main flow passages of the anode side separator to be seen in opened statuses. The cathode side separator and the anode side separator are folded in a valley to face one another along a center of a centerline L in the figure to permit an electrode electrolyte composite body (MEA) to be sandwiched to form a unit cell in a manner as will be described later.

FIG. 2 is a cross sectional view of the unit cell of the fuel cell of the presently filed embodiment, with a cross section taken on line A-A of a cathode side separator, a cross section taken on line B-B of an anode side separator and a cross section including through-bores of MEA of FIG. 1 being correspondingly combined so as to form one cross sectional structure.

In FIG. 1, a cathode side separator 1 is formed with six parallel main flow passages 4. Formed at one end of the separator 1 and thoroughly extending to open in a direction perpendicular to a sheet surface of FIG. 1 is an inlet manifold 5, through which oxidizing gas (cathode gas: air) forming one reaction gas is supplied and distributed to the six parallel main flow passages 4. The inlet manifold 5 also serves as a distribution manifold. Further, the main flow passages 4 are formed in a swirling configuration grouped together in parallel and have terminal end portions 6 formed in close proximity to the center of the separator 1.

With the cathode side separator 1, cathode gas flows to the terminal end portions 6 and further flows in a direction perpendicular to the sheet surface of FIG. 1 into a confluent flow passage (confluent manifold) 7 formed on an anode side separator 2 via through-bores 13a, serving as opening portions, formed in an electrolyte layer 13 at areas in compliance with the terminal end portions 6 of the main flow passages of the cathode side separator 1 as shown in FIG. 2. Then the cathode gas flows in the confluent flow passage 7. Here, the electrolyte layer 13 is made of solid polymer material.

Here, in FIG. 2, reference numerals 14, 15 designate gas dispersion electrodes formed with catalytic layers, not shown, respectively, with the gas dispersion layers 14, 15 being carried on both sides of the electrolyte layer 13, respectively. Namely, the MEA includes the gas dispersion electrode 14, the electrolyte layer 13 and the gas dispersion electrode 15 which are stacked in sequence and joined to one another to form a composite body in which the cathode side separator 1 is placed on the gas electrode 14 and the anode side separator 2 is placed on the gas dispersion layer 15. In general, the gas dispersion electrode including the catalytic layer is formed in a rectangular shape and disposed at a central area of the electrolyte layer, and in contrast, with the structure of the presently filed embodiment, even though the gas dispersion electrodes 14, 15 have the rectangular shapes, the gas dispersion electrodes 14, 15 have opening portions formed in close proximity to the through-bores 13a of the electrolyte layer 13, which enable gas to flow from the terminal end portions 6 of the main flow passages 4 of the cathode side separator 1 into the confluent flow passage 7, i.e., in areas 16, 17, respectively, where the gas dispersion electrodes 14, 15 are nonexistent.

Then, gas entering the confluent flow passage 7 continues to pass through the confluent flow passage 7 into an outlet manifold 8, which extends thoroughly in the anode side separator 2 along a direction perpendicular to the sheet of FIG. 1, to allow gas to flow outside the unit cell, i.e., to be exhausted outside the fuel cell stack.

Here, during the course of executing steps previously mentioned, oxidizing gas flowing through the main flow passages 4 of the cathode side separator 1 is supplied to and dispersed through the gas dispersion electrode 14 to reach a vicinity of the electrolyte layer 13.

On the other hand, with the anode side separator 2, fuel gas (anode gas: hydrogen) serving as the other reaction gas is supplied from an inlet manifold 9, which is formed at one end of the separator 2 and extends thoroughly in a direction perpendicular to the sheet surface of FIG. 1, and distributed to six main flow passages 4a that extend parallel to one another. The main flow passages 4a are formed in a “S-shaped” configuration grouped together in parallel and have terminal end portions 6a formed at the other end of the anode side separator 2 to be opposite to the inlet manifold 9. The terminal end portions 6a of the main flow passages 4a are held in communication with an outlet manifold 10 that is formed to open through the separator 2 in a direction perpendicular to the sheet surface of FIG. 1.

With the anode side separator 2 with the structure set forth above, gas arriving at the terminal end portions 6a flows into the outlet manifold 10 and exhausted outside the fuel cell stack.

Here, during the course of executing steps previously mentioned, fuel gas flowing through the main flow passages 4a of the anode side separator 2 is supplied to and dispersed through the gas dispersion electrode 15 to reach a vicinity of the electrolyte layer 13, thereby permitting hydrogen ion contained in fuel gas being transferred through the electrolyte layer 13 and directed to the gas dispersion electrode 14 to finally react with oxygen contained in oxidizing gas.

Namely, in general, the related art fuel cell has no anode gas flow passages and cathode gas flow passages that are simultaneously formed in a common plane to which both the separators face at areas except for the manifolds extending through the separators, respectively. On the contrary, one of the features of the embodiment of the invention resides in that the confluent flow passage 7, for cathode gas, is formed in the vicinity of the center of the anode side separator 2, which is formed with the anode gas flow passages 4a, at the area corresponding to the terminal end portions 6 of the main flow passages 4 formed in the vicinity of the center of the cathode side separator 1.

Also, the separators 1, 2 have seals 11, 12, respectively, which shut off gas leakages among the flow passages 4, 4a, formed in the separators 1, 2, respectively, and the MEA. The seals 11, 12 have basic shapes identical with contours of associated separators 1, 2. However, the seal 11 of the cathode side separator 1 is additionally formed with seal members 11a, 11b that shut off the main flow passages 4 and the inlet manifold 5 of the cathode side separator 1 from the inlet manifold 9 and the outlet manifold 10 for fuel gas via the MEA. Similarly, the seal 12 of the anode side separator 2 is formed with a seal member 12a that shuts off the inlet manifold 5 of the cathode side separator 1 from the anode side separator 2 via the MEA and, in addition, formed with a seal member 12b that shuts off the confluent passage 7, formed on the anode side separator 2, from the main flow passages 4a formed on the anode side separator 2.

As previously set forth above, since the fuel cell of the presently filed embodiment is structured with the fuel gas flow passages and the oxidizing gas flow passages both of which are formed on the common plane of the anode side separator 2 that faces the electrolyte layer 13 while the electrolyte layer 13 is formed with the through-bores 13a through which gas is supplied from the flow passages formed on the cathode side separator 1 toward the anode side separator 2 opposite thereto via the electrolyte layer 13, an increased three-dimensional freedom is provided in design of the main flow passages.

With such a structure, accordingly, it becomes possible to realize a structure with the cathode side separator, formed with the main flow passages configured in a shape where one terminal end portions of the flow passages are surrounded with other portions of the flow passages to result in deadlocks, which would otherwise be hard to be realized in the related art fuel cell.

Further, with the structure of the presently filed embodiment, the through-bores extending through the electrolyte layer to admit gas are disposed in downstream areas of the gas flow passages.

Consequently, with such a structure, since the amount of gas flowing through the curved flow passages toward the through-bores extending through the electrolyte layer is decreased, pressure losses appearing in such areas and the through-bores are minimized.

Furthermore, with the presently filed embodiment, the anode side separator is enabled to have the confluent manifold that can be formed without overlapping with the other component elements in a thickness direction.

Accordingly, with such a structure, it becomes possible for the anode side separator to have a reduced thickness.

Also, it is of course to be appreciated that the invention is not limited to particular numeric description for the number of flow passages of the separators and particular description related with the configurations such as the shapes of the flow passages of the separators and the shapes of the electrodes and may take any other suitable structures if desired.

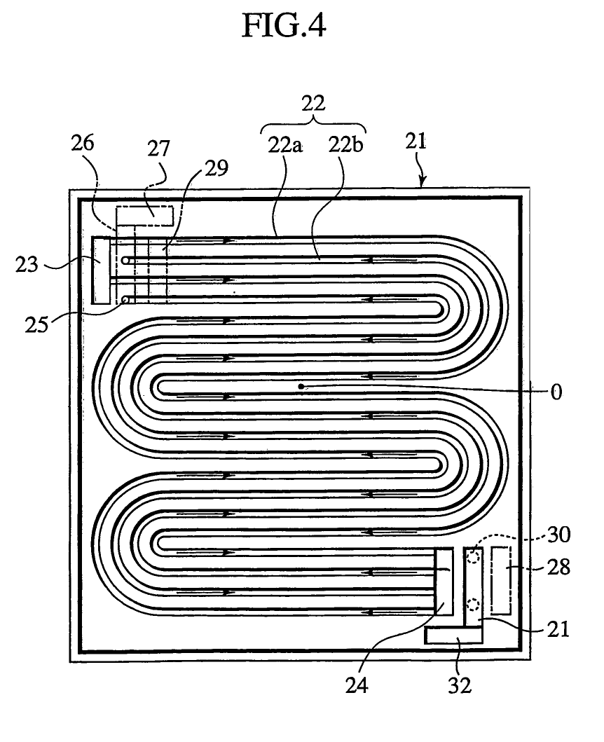

One of such structures includes a gas dispersion electrode with a structure shown in FIG. 3. FIG. 3 simultaneously illustrates not only the anode side separator 2 and the gas dispersion electrode 15 but also the cathode side separator 1 and the gas dispersion electrode 14, with the anode side separator 2 and the gas dispersion electrode 15 as well as the cathode side separator 1 and the gas dispersion electrode 14 shown as viewed in a direction of an arrow X in FIG. 2.

In FIG. 3, opening portions are formed not only at areas in compliance with the through-bores 13a of the electrolyte layer 13, but also at areas 17′, 16′ entirely in compliance with the confluent passage 7 formed on the anode side separator 2 to preclude the presence of the gas dispersion electrodes 15, 14. In such a case, each of the gas dispersion electrodes 15, 14 takes a so-called modified U-shaped outer configuration.

(Second Embodiment)

Now, a fuel cell and its related method of flowing gases in a second embodiment according to the present invention are described below more in detail mainly with reference to FIG. 4. The presently filed embodiment basically has the same fundamental structure as the first embodiment, but differs from the first embodiment in that reaction gas flow passages of the cathode side separator and the anode side separator include pluralities of main flow passages extending parallel to one another in turns and the adjacent flow passage components of the flow passages are arranged to allow gas to flow in directions opposite to one another. Further, with the presently filed embodiment, as will be described later in detail, the flow passages of the cathode side separator and the manifolds substantially have symmetric relationships with respect to those of the anode side separator. Therefore, like components parts of the second embodiment bear the same reference numerals as those of the first embodiment in consideration of various points different from or similar to those of the first embodiment while suitably omitting redundant description of the same structure or simplifying the description.

FIG. 4 is a plan view of a cathode side separator of the presently filed embodiment as viewed from the electrolyte layer. Also, for a convenience of description, FIG. 4 shows portions of components parts with the anode side separator as viewed from a side opposite to the electrolyte layer, i.e., the portions of the component parts as viewed in the arrow X in FIG. 2 that has been previously described.

In FIG. 4, reaction gas is supplied to a cathode side separator 21 through an inlet manifold 23 that extends through the cathode side separator 21 in a direction perpendicular to the sheet of the figure. The inlet manifold 23 also serves as a distribution manifold to distribute gas streams to main flow passages 22. The main flow passages 22 are formed of four parallel flow passage components configured in a reversed S-shape, with two main passage components 22a directly connected to the inlet manifold 23 while the other remaining main flow passage components 22b being out of direct connection with the inlet manifold 23.

Gas streams flowing through the inlet manifold 23 to the main flow passage components 22a pass through the main flow passage components 22a in the reversed S-shape to join at a turn manifold 24 once. Thereafter, gas streams joined at the turn manifold 24 flow into the remaining two main passage components 22b to pass in a direction opposite to the going main flow passage components 22a to reach terminal end portions 25 formed in close proximity to the inlet manifold 23. Since the terminal end portions 25 are surrounded with the inlet manifold 23 and the going main flow passage components 22a, gas streams flowing through the returning main flow passage components 22b result in deadlocks on a plane of the cathode side separator 21, but, as in the first embodiment, gas streams appearing at the terminal end portions 25 pass through through-bores, not shown, which open in the electrolyte layer and flow into a confluent manifold 26 formed in the anode side separator from which the gas streams flow into an outlet manifold 27 extending through the anode side separator and are exhausted outside the fuel cell stack.

Here, although FIG. 4 principally illustrates the flow passages and the manifolds of the cathode side separator 21, the anode side separator has associated gas flow passages and manifolds that are formed in symmetric relationship with those of the cathode side separator. More particularly, for a convenience of description, referring to FIG. 4 showing the portions of the component parts of the anode side separator, as viewed from the side opposite to the electrolyte layer, the component elements of the separators substantially remain in a point symmetric relationship with respect to a center O of the separators in FIG. 4.

When describing the flow of reaction gas in the anode side separator in a simplified form, reaction gas appearing at the anode side separator is supplied through an anode side inlet manifold designated at 28 in FIG. 4, and reaction gas streams pass through the main flow passages, not shown, in a direction opposite to that of the cathode side separator 21 and turn up at a turn manifold 29 whereupon reaction gas streams flow through the main flow passages, not shown, in a direction opposite to that of the cathode side separator and return to terminal end portions 30. While the gas streams result in deadlocks on a plane at the terminal end portions 30, the gas streams pass through the through-bores, not shown, opening in the electrolyte layer to flow into a confluent manifold 31, formed in the cathode side separator 21, from which gases are exhausted outside the fuel cell stack via an outlet manifold 32 extending through the cathode side separator 21.

As previously set forth above, with the presently filed embodiment, a structure is realized such that both the flow passages for fuel gas and the flow passages for oxidizing gas are formed in the same plane as those of the cathode side separator and the anode side separator, and also an attempt is made to permit the associated reaction gas streams to flow from the main flow passages formed on one separator to the flow passages formed on the other separator via the through-bores that open in the electrolyte layer.

With such a structure, accordingly, a freedom in design of the flow passages of the respective separators is highly increased; making it possible to realize the separator formed with flow passage configurations with terminal end portions resulting in deadlocks.

Further, with the presently filed embodiment, directions of the gas streams passing through the adjacent flow passage components are mutually opposite with respect to one another, resulting in a structure where the flow passages have upstream portions and downstream portions which are mutually adjacent to one another.

Consequently, with such a structure, excessive moisture produced through electric power generating reaction to excessively appear at the downstream is dispersed in the upstream area via the gas dispersion electrode formed on the surface of the electrolyte layer, making it possible to establish a desired balance between water required for moistening the electrolyte layer and water produced due to reaction.

Further, the presently filed embodiment has a structure to permit the gas streams to be delivered through the electrolyte layer at the areas near the terminal end portions of the returning flow passage components that are turned, i.e., at downstream areas of the gas flow passages.

Accordingly, such a structure enables gas to flow through the bending flow passages directed toward the through-bores extending through the electrolyte layer at a lower flow rate than those of gases merely flowing in the opposite directions, pressure losses can be reduced in such areas and in such through-bores.

Furthermore, the presently filed embodiment concerns a structure wherein the respective confluent manifolds are formed without causing the other component parts to overlap with respect to one another in a thickness direction of the cathode side separator and the anode side separator.

Consequently, such a structure has a capability of reducing the thickness of the cathode side separator and that of the anode side separator, respectively.

Also, with the presently filed embodiment, while the component elements of the cathode side separator and the component elements of the anode side separator are arranged in the symmetric relation, it is of course that the invention is not limited to such a particular arrangement and may take an arrangement in a non-symmetric relationship.

(Third Embodiment)

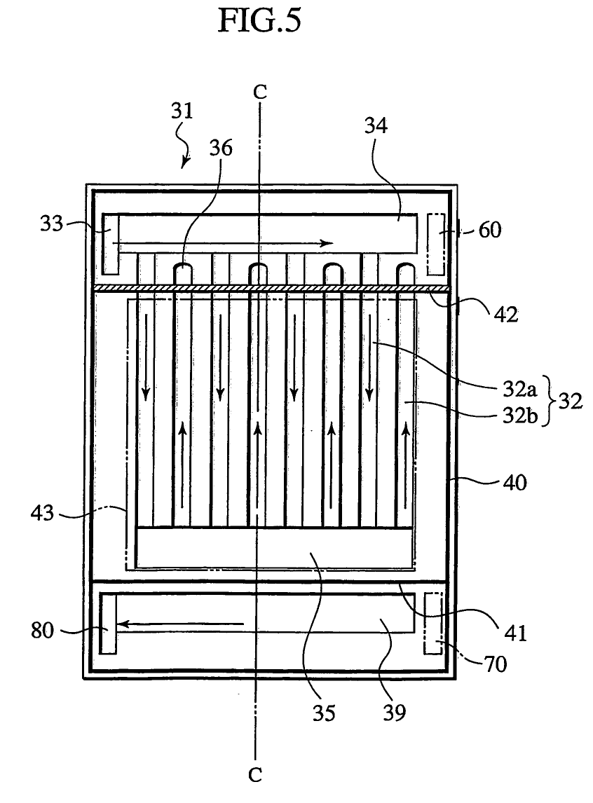

Now, a fuel cell and its related method of flowing gases in a third embodiment according to the present invention are described below more in detail mainly with reference to FIGS. 5 to 7. The presently filed embodiment basically adopts the same fundamental structure as that of the second embodiment but differs from the second embodiment in that the plurality of the main flow passages are not formed in curved shapes but in linear parallel shapes. Further, even with the presently filed embodiment, the flow passages and the manifolds of the cathode side separator have a symmetric relationship with those of the anode side separator. Therefore, like components parts of the third embodiment bear the same reference numerals as those of the second embodiment in consideration of various points different from or similar to those of the second embodiment while suitably omitting redundant description of the same structure or simplifying the description.

FIG. 5 is a plan view of a cathode side separator of the presently filed embodiment as viewed from an electrolyte layer. Also, for a convenience of description, FIG. 5 shows portions of components parts with the anode side separator as viewed from a side opposite to the electrolyte layer, i.e., the portions of the component parts as viewed in the arrow X in FIG. 2 that has been previously described.

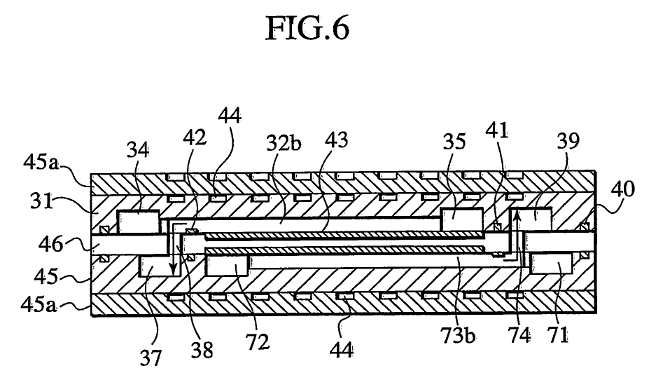

FIG. 6 is a cross sectional view of a unit cell of a fuel cell of the presently filed embodiment, illustrating a cross sectional structure combined with a cross section taken on line C-C of a cathode side separator, an associated cross sectional part of an anode side separator and an associated cross sectional part of a MEA.

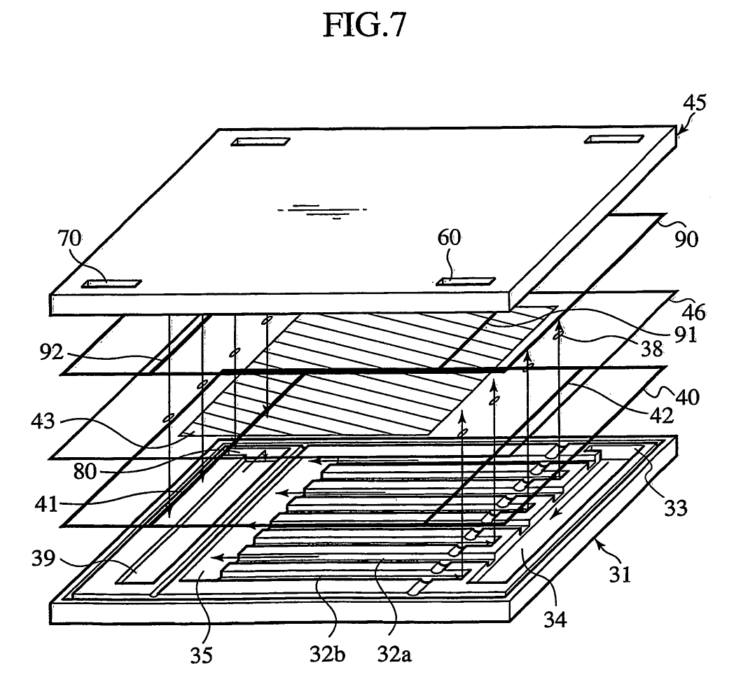

FIG. 7 is an exploded perspective view of the unit cell of the fuel cell of the presently filed embodiment.

Referring to FIGS. 5 to 7, reaction gas supplied from an inlet manifold 33 that extends through a cathode side separator 31 in a direction perpendicular to the sheet of FIG. 5 flows into a channel-shaped distribution manifold 34 that does not extend through the cathode side separator 31. The distribution manifold 34 serves to distribute gas to four parallel, linear shaped, main going flow passage components 32a of a main flow passage 32.

Then, gas diverges into a plurality of gas streams which flow into the main going flow passage components 32a, among the main flow passages 32, formed in every other one piece so as to extend parallel with respect to one another. The gas streams flowing through the main going flow passage components 32a are joined at a turn manifold 35 once and distributed to main returning flow passage components 32b to allow gas streams to flow in a direction opposite to that of the main going gas flow passage components 32a.

Thus, the gas streams flow through the main returning gas flow passage components 32b, among the main flow passages 32, to terminal end portions 36 and, in such a case, although the gas streams result in deadlocks on a plane of the cathode side separator 31, the gas streams flow into a confluent manifold 37, formed on the anode side separator 45, via through-bores 38 opening in an electrolyte layer 46. Here, the through-bores 38 are formed in the electrolyte layer 46 at positions in compliance with the terminal end portions 36 of the main returning gas flow passage components 32b to permit gas flow in the same number as those of the main flow passage components 32a.

Subsequently, gas flows out from the confluent manifold 37 and is exhausted outside the fuel cell stack from an outlet manifold 60 formed in the anode side separator 45 so as to extend therethrough. Also, coolant passages 44 are formed at a mating portion between the anode side separator 45 and a flat plate member 45a as will be described below.

On the other hand, the flow passages and the manifolds of the anode side separator 45 substantially have a point symmetric relationship with those of the cathode side separator 31 in FIG. 5 like in the second embodiment.

Describing the flow of reaction gas in the anode side separator 45 in a simplified form, reaction gas supplied to the anode side separator 45 via an anode side inlet manifold 70, which extends through the anode side separator 45 in a direction perpendicular to the sheet of FIG. 5, flows through the distribution manifold 71, the main going gas flow passages which are not shown, a turn manifold 72, main returning gas flow passage components 73b, through-bores 74 formed in the electrolyte layer 46, and a confluent manifold 39 formed in the cathode side separator 31 and exhausted outside the fuel cell stack via an outlet manifold 80 formed in the cathode side separator 31.

Also, reference numeral 40 designates a seal that includes a seal portion configured in the same shape as a contour of the cathode side separator 31, and a seal portion 41 that separates the gas flow passages of the cathode side separator 31 from the gas flow passages of the anode side separator 45. Further, additionally mounted is a bridge seal 42 that bears counter-acting pressure exerted with the seal portion 41 of the seal 40 of the anode side separator 45. A seal 90 of the anode side separator 45 also has a similar structure that includes a seal portion 91 and a bridge portion 92.

Further, reference numeral 44 designates the coolant passages that are formed at the mating portion between the anode side separator 45 and the flat plate member 45a and also at a mating portion between the cathode side separator 31 and the flat plate member 45a.

Furthermore, it is conceived that a reacting field surface of such a unit cell is deemed to be formed in an area sandwiched between the turn manifold 35 of the cathode side separator 31 and the turn manifold 51 of the anode side separator 45 at a side of the dispersion electrode 43 located closer to the cathode side separator 31.

As previously set forth above, with the presently filed embodiment, a freedom in design of the flow passages of both of the cathode side separator and the anode side separator is highly increased like in the second embodiment, and in addition, it is possible for a balance between water required for moistening and water produced through reaction to be favorably established while at the same time, enabling a pressure loss of gas to be eliminated.

Further, with the presently filed embodiment, since the respective confluent manifolds are formed in the cathode side separator and the anode side separator without causing other components parts to be overlapped in a direction along thickness of the cathode side separator and the anode side separator, a dimensional margin can be created in the thickness direction of the respective separators, and the use of such a structure enables the coolant passages to be internally formed in the respective separators.

Consequently, such a structure set forth above has a capability of maintaining a compact structure while enabling the unit cell to be effectively cooled.

(Fourth Embodiment)

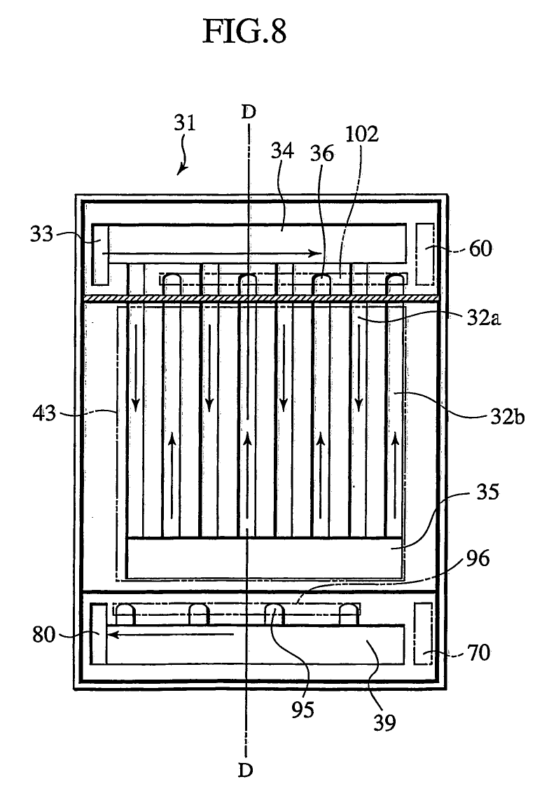

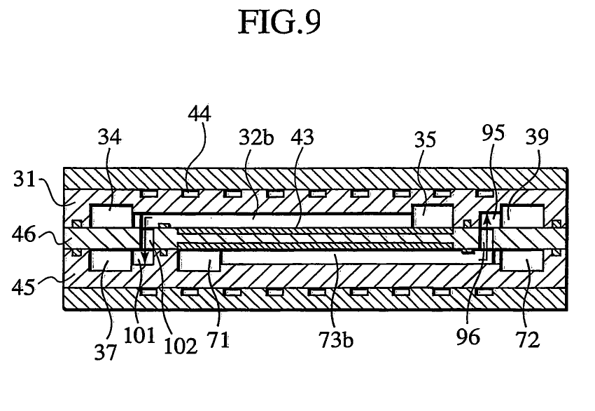

Now, a fuel cell and its related method of flowing gases in a fourth embodiment according to the present invention are described below more in detail mainly with reference to FIGS. 8 and 9. The presently filed embodiment basically adopts the same structure as that of the third embodiment but differs from the third embodiment mainly in shape of flow passage configurations in the vicinity of confluent manifolds. Further, with the presently filed embodiment, flow passages and manifolds of the cathode side separator have a symmetric relationship with those of the anode side separator. Therefore, like components parts of the fourth embodiment bear the same reference numerals as those of the third embodiment in consideration of various points different from or similar to those of the third embodiment while suitably omitting redundant description of the same structure or simplifying the description.

FIG. 8 is a plan view of a cathode side separator of the presently filed embodiment as viewed from an electrolyte layer. Also, for a convenience of description, FIG. 8 shows portions of components parts with the anode side separator as viewed from a side opposite to the electrolyte layer.

FIG. 9 is a cross sectional view of a unit cell of the fuel cell of the presently filed embodiment, illustrating a cross sectional structure combined with a cross section taken on line D-D of a cathode side separator, an associated cross sectional part of an anode side separator and an associated cross sectional part of a MEA.

In FIGS. 8 and 9, the fourth embodiment does not concern to a structure of the confluent manifold 39 simply formed on the cathode side separator 31 in a rectangular shape as seen in the third embodiment, but features that branch flow passages 95 are formed on the cathode side separator 31 in communication with the confluent manifold 39 and extend in branched configurations in directions parallel to one another in compliance with main returning flow passage components 73b of the anode side separator 45. Further, the fourth embodiment does not contemplate the provision of the through-bores in the electrolyte layer 46 with the same number as that of the terminal end portions of the main returning flow passage components 73b as seen in the third embodiment, but features the formation of an elongated slot 96 that is common to the terminal end portions of the whole main returning flow passage components 73b, in the electrolyte layer 46.

On the other hand, similarly, the anode side separator 45 is formed with branch flow passages 101 in communication with the confluent manifold 37 and extend in branched configurations in directions parallel to one another in compliance with main returning flow passage components 32b of the cathode side separator 31 to have the same number as that of the terminal end portions 36 of the main returning flow passage components 32b of the cathode side separator 31, and the electrolyte layer 46 is formed with an elongated slot 102 commonly in communication with the terminal end portions 36 of the whole returning main flow passage components 32b.

As set forth above, with the presently filed embodiment, the presence of the branch flow passages provides no need for forming the through-bores in the electrolyte layer in compliance with the terminal end portions of the returning main flow passage components. This results in a mere formation of the elongated slot commonly opening to the terminal end portions of the whole returning main flow passage components to enable gas to surely flow into the flow passage components of the other separator, with a resultant advantage to enable a further simplified structure to be realized in addition to the advantage of the third embodiment.

Incidentally, in an event that the electrolyte layer is formed with the elongated slot in place of the discrete through-bores as in the presently filed embodiment, it is supposed that inlet vicinities of the main going flow passage components and vicinities of the terminal end portions of the returning main flow passage components are short circuited via the elongated slot to cause gas to hardly flow through the main flow passage components. Namely, the inlet vicinities of the main going flow passage components and vicinities of the terminal end portions of the main returning flow passage components are exposed to the elongated slot, and it is conceived that there are short-circuited flow passages substantially equal in thickness to the thickness of the electrolyte layer.

However, even if there are such areas in which gases are short circuited, in the first place, gases of the same kind are mutually and merely mixed with one another and, also, the thickness of the short-circuited area corresponding to the thickness of the electrolyte layer is extremely small as compared to the thickness of the main flow passage components, resulting in an increased pressure loss while, during actual operation, moisture permeates through such a thin short-circuited area to provide a further increased pressure loss. Thus, it is conceived that the short-circuited status per se is hard to appear and is almost practically negligible.

Also, while the presently filed embodiments set forth above have been representatively described with reference to examples of the solid polymer type fuel cell, it is of course to be understood that the present invention may be suitably applied to the other kinds of fuel cells such as a fuel cell using a solid oxide electrolyte material.

The entire content of a Patent Application No. TOKUGAN 2002-3559 with a filing date of Jan. 10, 2002 in Japan is hereby incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

### INDUSTRIAL APPLICABILITY

As set forth above, according to the invention, since both of the flow passages for fuel gas and the flow passages for oxidizing gas are formed on the substantially same plane of one of the separators, it is possible to remove restrictions of avoiding inclusions of the fuel gas flow passages and the oxidizing gas flow passages on the same plane of the separator, thereby resulting in an increase in the freedom in design of the flow passages. Thus, the fuel cell having such a separator is applicable to the fuel cells of not only the solid polymer type but also the other type such as the solid oxide type, and resultantly such a fuel cell is applicable to fuel cell powered automobiles as well as electric power generators for domestic use. Therefore, such an application of the present invention can be expected in a wide range.

1. A fuel cell comprising:
an electrolyte layer;
a first electrode layer adjacent to one surface of the electrolyte layer;
a first separator adjacent to the first electrode at one surface thereof remote from the electrolyte layer and formed with a flow passage;
a second electrode layer adjacent to the other surface of the electrolyte layer; and
a second separator adjacent to one surface of the second electrode layer remote from the electrolyte layer and formed with a flow passage, the flow passage formed on at least one of the first separator and the second separator including at least a part of fuel gas flow passage and at least a part of oxidizing gas flow passage.

2. The fuel cell according to claim 1, wherein the fuel gas flow passage and the oxidizing gas flow passage are formed on substantially the same plane of the at least one of the first separator and the second separator.

3. The fuel cell according to claim 2, wherein the fuel gas flow passage includes an inlet manifold to allow the fuel gas to flow in, a plurality of main flow passages communicating with the inlet manifold to allow streams of the fuel gas to flow, a confluent manifold communicating with the plurality of main flow passages to allow the streams of the fuel gas to be joined, and an outlet manifold communicating with the confluent manifold to allow the fuel gas to flow out, and the oxidizing gas flow passage includes an inlet manifold to allow the oxidizing gas flow in, a plurality of main flow passages communicating with the inlet manifold to allow streams of the oxidizing gas to flow, a confluent manifold communicating with the plurality of main flow passages to allow the streams of the oxidizing gas to be joined, and an outlet manifold communicating with the confluent manifold to allow the oxidizing gas streams to flow out, the inlet manifold into which one of the fuel gas and the oxidizing gas flows, the plurality of main flow passages through which one of the streams of the fuel gas and the oxidizing gas flows, the confluent manifold at which the other one of the streams of the fuel gas and the oxidizing gas are joined, and the outlet manifold through which the other one of the fuel gas and the oxidizing gas flows out being formed on substantially the same plane of the at least one of the first separator and the second separator.

4. The fuel cell according to claim 1, further comprising an opening portion formed in the electrolyte layer,
wherein, one of the fuel gas flow passage and the oxidizing flow passage, formed in the at least one of the first separator and the second separator, communicates through the opening portion with a corresponding flow passage of the other of the first separator and the second separator opposing to the at least one of the first separator and the second separator between which the electrolyte layer is sandwiched.

5. The fuel cell according to claim 1, wherein at least one of the fuel gas flow passage and the oxidizing gas flow passage includes an inlet manifold to allow corresponding one of the fuel gas and the oxidizing gas to flow in, a plurality of main flow passages communicating with the inlet manifold to allow streams of the corresponding one of the fuel gas and the oxidizing gas to flow, a confluent manifold communicating with the plurality of main flow passages to allow the streams of the corresponding one of the fuel gas and the oxidizing gas to be joined, and an outlet manifold communicating with the confluent manifold to allow the corresponding one of the fuel gas and the oxidizing gas to flow out, the inlet manifold and the plurality of main flow passages being formed on one of the first separator, and the second separator and the confluent manifold and the outlet manifold being formed on the other one of the first separator and the second separator.

6. The fuel cell according to claim 5, further comprising an opening formed in the electrolyte layer,
wherein the plurality of main flow passages communicate with the confluent manifold through the opening.

7. The fuel cell according to claim 6, wherein the plurality of main flow passages includes terminal end portions substantially surrounded with at least a part of the inlet manifold and at least a part of the plurality of main flow passages on the one surface of the first separator and the second separator on which the plurality of main flow passages are formed.

8. The fuel cell according to claim 7, wherein the a plurality of openings are disposed in the electrolyte layer in compliance with the terminal end portions of the plurality of main flow passages to allow the terminal end portions to communicate with the confluent manifold through the plurality of openings, respectively.

9. The fuel cell according to claim 8, wherein the at least one of the fuel gas flow passage and the oxidizing gas flow passage further includes a distribution manifold that communicates with the inlet manifold and distributes to corresponding one of the fuel gas flow passage and the oxidizing gas flow passage, and the terminal end portions of the plurality of the main flow passages are further substantially surrounded with at least a part of the distribution manifold.

10. The fuel cell according to claim 1, wherein at least one of the fuel gas flow passage and the oxidizing gas flow passage includes a plurality of main flow passages that are arranged to allow corresponding one of the fuel gas and the oxidizing gas to flow through adjacent ones of the plurality of main flow passage components in directions opposite to one another.

11. The fuel cell according to claim 10, further comprising:
a turn manifold disposed in a midway of the plurality of main flow passages,
wherein a stream of the corresponding one of the fuel gas and the oxidizing gas turns at the turn manifold to cause the stream of the fuel gas and the oxidizing gas to flow through the adjacent ones of the plurality of main flow passages in direction opposite to one another.

12. The fuel cell according to claim 11, wherein the at least one of the fuel gas flow passage and the oxidizing gas flow passage includes an inlet manifold disposed upstream of the plurality of main flow passages to allow the corresponding one of the fuel gas and the oxidizing gas to flow in, a confluent manifold disposed downstream of the plurality of main gas flow passages to allow the corresponding one of the fuel gas and the oxidizing gas to be joined, and an outlet manifold communicating with the confluent manifold to allow the corresponding one of the fuel gas and the oxidizing gas to flow out.

13. The fuel cell according to claim 1, wherein at least one of the fuel gas passage and the oxidizing gas flow passage includes an inlet manifold allowing to corresponding one of the fuel gas and the oxidizing gas to flow in, a plurality of main flow passages communicating with the inlet manifold to allow the corresponding one of the fuel gas and the oxidizing gas to flow, a confluent manifold communicating with the plurality of main flow passages to allow the corresponding one of the fuel gas and the oxidizing gas to be joined, and an outlet manifold communicating with the confluent manifold to allow the corresponding one of the fuel gas and the oxidizing gas to flow out,
and wherein the confluent manifold has a plurality of branch flow passages disposed in compliance with terminal end portions of the plurality of main flow passage components.

14. The fuel cell according to claim 13, further comprising an opening portion formed on the electrolyte layer to be common to the terminal end portions of the plurality of main flow passages,
wherein the terminal end portions of the main flow passages communicate with the plurality of branch flow passages through the opening portion.

15. A fuel cell comprising:
an electrolyte layer;
a first electrode layer adjacent to one surface of the electrolyte layer;
a first separator adjacent to the first electrode at one surface thereof remote from the electrolyte layer;
a second electrode layer adjacent to the other surface of the electrolyte layer;
a second separator adjacent to one surface of the second electrode layer remote from the electrolyte layer;
first communicating means for communicating fuel gas; and
second communicating means for communicating oxidizing gas, at least one of the first separator and the second separator being formed with at least a part of the first communicating means and at least a part of the second communicating means.

16. A method of flowing gases in a fuel cell, which is provided with an electrolyte layer, a first electrode layer adjacent to one surface of the electrolyte layer, a first separator adjacent to the first electrode at one surface thereof remote from the electrolyte layer and formed with a flow passage, a second electrode layer adjacent to the other surface of the electrolyte layer and a second separator adjacent to one surface of the second electrode layer remote from the electrolyte layer and formed with a flow passage, the method comprising:
flowing one of the fuel gas and the oxidizing gas to the flow passage of the first separator;
introducing the one of the fuel gas and the oxidizing gas, which flows through the flow passage of the first separator, to the second separator;
flowing the one of the fuel gas and the oxidizing gas to one part of the flow passage of the second separator; and
flowing the other one of the fuel gas and the oxidizing gas to the other part of the flow passage of the second separator.
